(19) United States
(12) Patent Application Publication
(10) Pub. No.: US 2012/0114469 A1
(43) Pub. Date: May 10, 2012

(54) COMPOSITE HUB FOR A PRESSURE WAVE SUPERCHARGER

(75) Inventors: Georg Glitz, Paderborn (DE); Jan Araszkiewicz, Paderborn (DE); Christian Smatloch, Paderborn (DE)

(73) Assignee: Benteler Automobiltechnik GmbH Elsener Strasse 95, Paderborn (DE)

(21) Appl. No.: 13/375,068

(22) PCT Filed: Apr. 24, 2010
(86) PCT No.: PCT/DE10/00465

§ 371 Date: Nov. 29, 2011

(30) Foreign Application Priority Data
May 29, 2009 (DE) 10 2009 023 217.6

(51) Int. Cl. F02B 33/40

(52) U.S. Cl. 415/182.1

(57) ABSTRACT

The invention proposes that the shaft-hub connection of a rotatable cell rotor (7) of a gas-dynamic pressure wave machine (6) for charging a combustion engine be composed of individual sheet metal parts having a hub outer body made of a tube, or of a mixture of hub outer bodies (71), and a disk (18) as a cast shaft holder. According to the invention, this is to replace a shaft-hub connection that is a solid casting.

The invention relates to a gas-dynamic pressure wave machine for charging a combustion engine, having a cell rotor which is rotatably mounted on a shaft in a housing and arranged between a supply duct for charge air and an exhaust pipe for combustion gases, according to the preamble of claim 1.

Charge systems which generate gas-dynamic processes in closed gas ducts and use them for charging are generally designated as pressure wave superchargers or pressure wave machines. The cell rotors have cylindrical configuration and normally include axially straight ducts having constant cross section and extending from the hot gas side to the cold gas side. A cell rotor made from sheet metal parts and having non-cylindrical outer contour is disclosed in DE 10 2007 021 367 A1. The supporting internal system of the cell rotor in the form of a shaft-hub-connection can be produced through a material-removing process. This involves a shaft having respective bearings and provided also with appropriate seals. The shaft supports hereby a hub shaped as a truncated cone to which a cell structure of the cell rotor is secured.

GB 920,624 also discloses a cell rotor made from sheet metal and including an inner cylinder and an outer cylinder and intermediate walls which extend between the two cylinders and which mutually contact one another in the form of a Z, a U, or an I. The inner and outer cylinders are produced by rolling a metal sheet to a cylinder of appropriate size and then welding it along a longitudinal seam. The actual shaft-hub connection about which the cell rotor rotates is not illustrated in further detail.

A problem associated with current systems is the thermal load collective to which the entire component geometry is subjected. The hot gas side of the cell rotor encounters temperatures of up to 1,100° C. and the cold gas side encounters temperatures of maximal 200° C. This leads to a heat-caused component distortion, resulting in a suboptimal efficiency. The dimensional precision of the gap between the gas-carrying elements poses especially problems. Therefore, cell rotors that have been produced on a large scale in automobiles and used in pressure wave machines are normally made from cast material. As a cast pressure wave machine is however relatively expensive and heavy, efforts have increasingly been directed to the production of a rotor from sheet metal. The shaft-hub connection including a hub outer body to receive the connection still were made heretofore as casting because of the complexity of the components. Anisotropic thermal stress renders it however problematic to select different materials for the cell structure of the rotor and the hub. Moreover, the high temperature-resistant materials used heretofore render any finishing operation to produce the final size complex and time-consuming.

It is therefore the object of the present invention to provide an improved gas-dynamic pressure wave machine with a lighter shaft-hub connection which can be produced with little effort.

This object is solved in accordance with the invention by a gas-dynamic pressure wave machine for charging a combustion engine, having a cell rotor rotatably mounted on a shaft in a housing and arranged between a supply duct for charge air and an exhaust pipe for combustion gases, wherein the shaft is received in a tube of sheet metal as hub outer body and the bore for holding the shaft is configured in a disk mounted in the hub outer body, or wherein a piece of tube of smaller diameter than the tube of the hub outer body to hold the shaft is mounted in the hub outer body. The hub outer body may hereby be made like the cell rotor form a sheet metal material of higher quality. The interior of the hub outer body thus affords a new degree of freedom as far as material selection is concerned. The disk can be a component which is produced by casting or forging and in which a bore can be formed for holding the shaft. As an alternative, the disk may also be a relatively simple stamped part. Preferably, the disk is provided with recesses, resembling a rim star. The provision of the rim star limits the component size and thus the corresponding weight to a minimum, even when the disk is cast. A shaft is received in the bore of the rim star and secured. The rim star or the disk are joined with an inner wall of the hub outer body, for example welded or soldered.

Preferably, the entire hub is made from sheet metal parts. An inner tube of smaller diameter is hereby used as the hub outer body to receive the shaft. This inner tube of smaller diameter is then held radially by a separate sheet metal part in the hub outer body. The inner tube that holds the shaft extends only over a partial length of the outer hub body. It has sufficient wall thickness to withstand stress. The tube is then held again by one or more individual parts. Preferably, this involves sheet metal parts. The sheet metal part may be attached in the hub outer body radially or at an angle to the cross sectional plane of the hub outer body. The sheet metal part may especially be curved convexly or concavely to compensate stress, manufacturing tolerances and/or heat distortion. To ensure a reliable seat of the inner tube, several sheet metal parts are preferably provided between inner tube and hub outer body in spaced-apart relationship. The inner wall of the hub outer body can be contoured to ensure a snug fit of individual parts or to compensate tolerances. One or more heat shields are preferably incorporated in the hub outer body at a distance to the shaft holder for protection of the sensitive bearings of the shaft against the hot exhaust-gas temperatures of up to 950° C.

The invention will now be described in greater detail with reference to the figures. It is shown in:

FIG. 1 a section through a hub according to the invention;

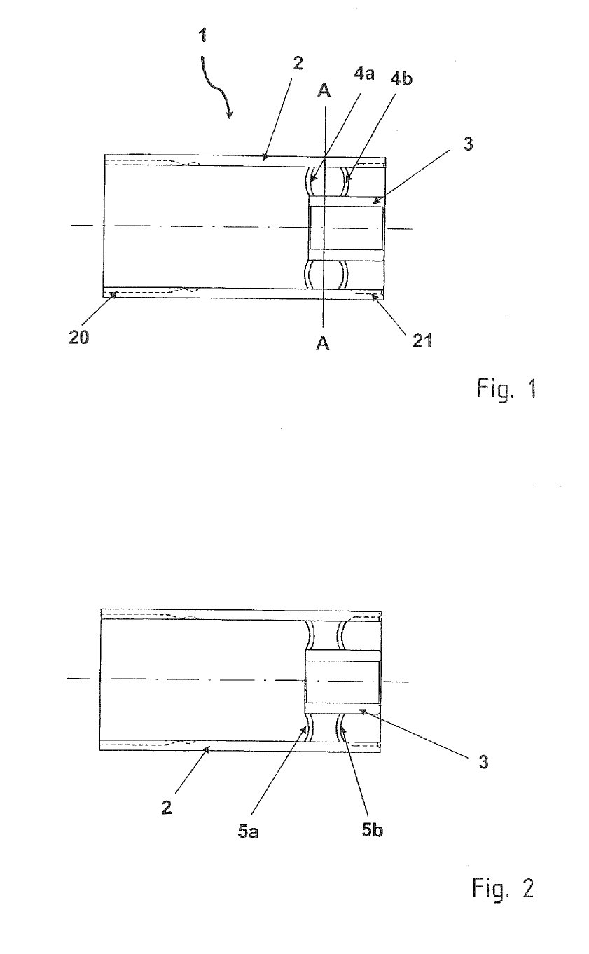

FIG. 2 a section through a further embodiment of a hub according to the invention; and

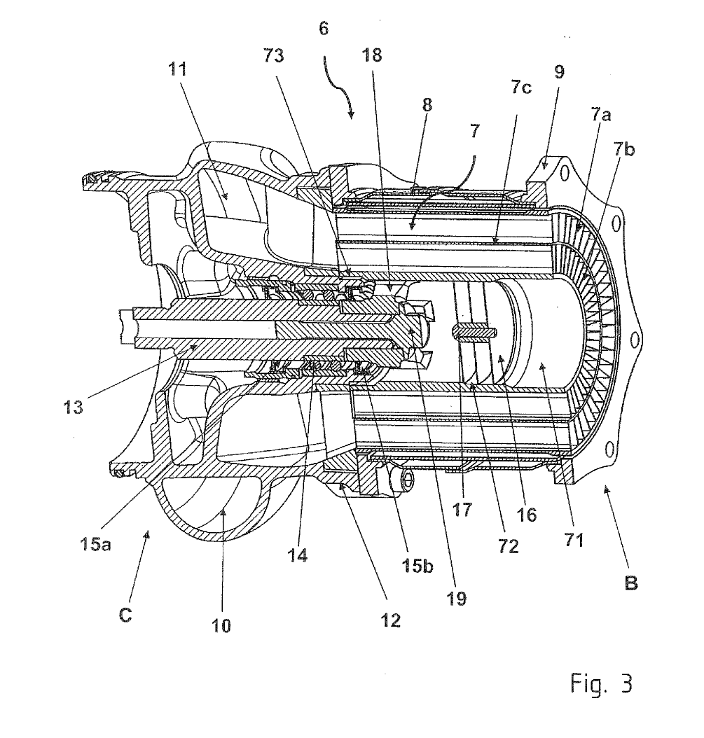

FIG. 3 a longitudinal section through a pressure wave supercharger in the area of the shaft-hub connection.

FIG. 1 shows a longitudinal section of a hub 1 according to the invention without shaft. The hub 1 has a cylindrical hub outer body 2 in which an inner tube 3 is held by sheet metal parts 4a, 4b arranged convexly relative to one another. The sheet metal parts 4a, 4b define an essentially bi-convex form between each other. Thus, the sheet metal parts 4a, 4b do not extend in parallel relation to a cross sectional plane A-A. In order to enable air trapped between the sheet metal parts 4a, 4b to expand when exposed to thermal stress, the sheet metal parts 4a, 4b are provided with recesses, not shown in greater detail, for a gas exchange.

FIG. 2 shows a similar construction, whereby the inner tube 3 is fixed here by a bi-concave shape between inwardly bulging sheet metal parts 5a, 5b in the hub outer body 2. The sheet metal parts 5a, 5b are thus shaped concavely in relation to one another. The hub outer body 2 is comprised of a tube drawn or welded from sheet metal, the same holds true for the inner tube 3. The inner tube 3 is provided for holding the not shown shaft. A region 20, 21 illustrates the possibilities to contour the inner wall of the hub outer body 2. As a result of the construction according to the invention, hub outer body 2, inner tube 3, and sheet metal parts 4a, 4b, 5a, 5b can have various materials. The hub 1 overall is lighter and can be produced more flexibly.

FIG. 3 shows a longitudinal section of a pressure wave machine 6. The pressure wave machine 6 has a cell rotor 7 which has two rows 7a, 7b of cells which are separated by a metal sheet 7c. The rows 7a, 7b of the cell rotor 7 are arranged about a cylindrical hub outer body 71. The cell rotor 7 is connected with the hub outer body 71 and has a connection for rotatable support in relation to a shaft 13. The cell rotor 7 is surrounded by a fixed double-walled housing 8 which can be connected via a housing attachment 9 with a hot gas side B, not shown in greater detail. The cell rotor 7 is connected with an intake tract 10 and a charge air duct 11 on a cold gas side C in opposition to the hot gas side B. The intake tract 10 and the charge air duct 11 are located in a common cast housing 12.

The shaft 13 is rotatably mounted via ball bearings 14 in the cast housing 12. At its end facing away from the cell rotor 7, the shaft 13 is secured to a drive motor, not shown in greater detail. The ball bearings 14 are protected against contaminations by cover and seals 15a, 15b.

In accordance with the invention, the hub outer body 71 includes as inner tube of the cell rotor 7 a tube which is drawn seamless or welded. The inner wall of the hub outer body 71 has been contoured to an outline 72 to create a snug fit for three heat shields 16 arranged behind one another and connected to one another by a bolt 17. The heat shields 16 separate the hot gas side B from the cold gas side C inside the hub outer body 71. In order to allow air, trapped between the three heat shields 16, to expand when under thermal stress, the two heat shields 16 in facing relation to the cold gas side C are provided with a recess, not shown in greater detail, for a gas exchange. The first of the heat shields 16 which confronts the hot gas side B has a gastight configuration.

The hub outer body 71 is further contoured with an outline 73 in which the cast housing 12 can be pushed-in at sufficient clearance for unhindered rotatability of the cell rotor 7. The shaft 13 is inserted in a disk 18 in the form of a cast rim star and threadably engaged via a bolt 19 with the disk 18. The disk 18 is connected with the hub outer body 71 by a material joint.

Advantageously, the materials of the disk 18 and the hub outer body 71 can thus differ from one another. The individual configuration of the shaft-hub connection according to the invention is more complex than casting a hub in one piece. However, the individual configuration is cost-effective when greater quantities are involved and overall lighter.

### REFERENCE SIGNS

1—hub
2—hub outer body
3—inner tube
4a—sheet metal part
4b—sheet metal part
5a—sheet metal part
5b—sheet metal part
6—pressure wave machine
7—cell rotor
7a—row of cells
7b—row of cells
7c—metal sheet between 7a and 7b
8—housing
9—housing attachment
10—intake tract
11—charge air duct
12—cast housing
13—shaft
14—ball bearing
15a—cover and seal
15b—cover and seal
16—heat shield
17—bolt
18—disk
19—bolt
20—area of 2
21—area of 2
71—hub outer body
72—contoured outline
73—contoured outline
A-A—cross sectional plane
B—hot gas side
C—cold gas side

What is claimed is:

1-10. (canceled)

11. A gas-dynamic pressure wave machine for charging a combustion engine, comprising:
a housing;
a shaft; and
a cell rotor rotatably mounted on the shaft in the housing and arranged between a duct for charge air and an exhaust pipe for combustion gases,
wherein the shaft is held in one of two ways, a first way in which the shaft is received in a tube of sheet metal which defines a hub outer body and the shaft is received in a bore of a disk mounted in the hub outer body, a second way in which an inner tube of a smaller diameter than a tube of a hub outer body is mounted in the hub outer body for receiving the shaft therein.

12. The gas-dynamic pressure wave machine of claim 11, wherein the disk is provided with recesses resembling a rim star.

13. The gas-dynamic pressure wave machine of claim 11, further comprising a separate sheet metal part arranged in the hub outer body, wherein the inner tube is held radially by the separate sheet metal part.

14. The gas-dynamic pressure wave machine of claim 13, wherein the sheet metal part in the hub outer body is attached at an angle in relation to a cross sectional plane of the hub outer body.

15. The gas-dynamic pressure wave machine of claim 13, wherein the sheet metal part in the hub outer body is curved convexly or concavely.

16. The gas-dynamic pressure wave machine of claim 13, further comprising a plurality of said sheet metal part in the hub outer body for radially holding the inner tube in the hub outer body.

17. The gas-dynamic pressure wave machine of claim 16, wherein at least one of the sheet metal parts has a recess for a gas exchange.

18. The gas-dynamic pressure wave machine of claim 11, wherein the hub outer body has an inner wall with a contoured outline.

19. The gas-dynamic pressure wave machine of claim 11, further comprising at least one heat shield in the hub outer body at a distance to the shaft.

20. The gas-dynamic pressure wave machine of claim 19, further comprising a plurality of said heat shield, at least one of the heat shields being provided with a recess for gas exchange.

21. A gas-dynamic pressure wave machine for charging a combustion engine, comprising:
a shaft;
a cell rotor rotatably mounted on the shaft and arranged between a duct for charge air and an exhaust pipe for combustion gases, said cell rotor having a tube of sheet metal to define a hub outer body; and
a disk mounted in the tube and having a bore for receiving the shaft.

22. The gas-dynamic pressure wave machine of claim 21, wherein the disk is provided with recesses to define a star-shaped configuration.

23. The gas-dynamic pressure wave machine of claim 21, further comprising at least one heat shield, wherein the tube has an inner wall with a contoured outline to form a snug fit for the heat shield at a distance to the shaft.

24. The gas-dynamic pressure wave machine of claim 23, further comprising a plurality of said heat shield, at least one of the heat shields being provided with a recess for gas exchange.

25. A gas-dynamic pressure wave machine for charging a combustion engine, comprising:
a hub outer body having a tube defined by a first diameter;
a shaft;
a cell rotor rotatably mounted on the shaft and arranged between a duct for charge air and an exhaust pipe for combustion gases; and
an inner tube arranged in the hub outer body and defined by a second diameter which is smaller than the first diameter, said tube adapted for receiving the shaft therein.

26. The gas-dynamic pressure wave machine of claim 25, further comprising a sheet metal part arranged in the hub outer body, wherein the inner tube is held radially by the sheet metal part.

27. The gas-dynamic pressure wave machine of claim 26, wherein the sheet metal part in the hub outer body is attached at an angle in relation to a cross sectional plane of the hub outer body.

28. The gas-dynamic pressure wave machine of claim 26, wherein the sheet metal part in the hub outer body is curved convexly or concavely.

29. The gas-dynamic pressure wave machine of claim 26, further comprising a plurality of said sheet metal part in the hub outer body for radially holding the inner tube in the hub outer body.

30. The gas-dynamic pressure wave machine of claim 29, wherein at least one of the sheet metal parts has a recess for a gas exchange.
